(19) United States
(12) Patent Application Publication
(10) Pub. No.: US 2026/0010711 A1
(43) Pub. Date: Jan. 8, 2026

(54) FINE-TUNING LARGE LANGUAGE MODEL TO PREDICT AND ANALYZE TABULAR DATA USING HUMAN PREFERENCES

(71) Applicant: ACTIMIZE LTD., Ra'anana (IL)

(72) Inventors: Sumit KUMAR, Pune (IN); Prasad MHATRE, Pune (IN); Danny BUTVINIK, Haifa (IL)

(21) Appl. No.: 18/761,724

(22) Filed: Jul. 2, 2024

(51) Int. Cl. G06F 40/20

(52) U.S. Cl. CPC G06F 40/20

(57) ABSTRACT

A method for training a machine learning (ML) model using a large language model (LLM) is provided. A system for detecting fraud which utilizes the LLM-trained ML model trained is also provided. An artificial intelligence (AI)-based method for monitoring alerts is also provided. The method for training an ML model using an LLM includes receiving tabular data for training the ML model, generating one or more natural-language strings comprising information from the tabular data, generating, via a base LLM, one or more prompts and completions based on the one or more generated natural-language strings, pre-training the base LLM using a plurality of generated prompts and completions, updating the base LLM via supervised learning using a cross-entropy loss function with ground-truth labels, and fine-tuning the updated LLM via reinforcement learning with human feedback using a reward model and a proximal policy optimization model to produce the LLM-trained ML model.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) systems, large language models (LLMs), and machine learning (ML) models, such as those that may be used for fraud predictions, and more specifically to a system and method for training ML models using LLMs, and systems and methods that use the LLM-trained ML models for monitoring alerts and/or for detecting frauds.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Large language models (LLMs), such as ChatGPT, have had a profound effect on artificial intelligence (AI) technological revolution. These models, trained on global knowledge, exhibit remarkable prowess in understanding intricate semantic relationships within textual data. With an adept understanding of user queries, they offer resolutions with finesse. Recognizing the abundance of tabular data in various industries, however, user queries in tabular data format are not quite formatted correctly and readily ingestible for current LLMs, which excel with text-based data with the most prevalent format being natural-language strings of data.

Recognizing such inadequacy for tabular data in various leading LLMs, there is yet to be a system or method for streamlining the conversion of tabular data into LLM-friendly data format. Indeed, there is yet to be a system or a method that can perform conversion of tabular data while safeguarding data privacy by eliminating the need to share sensitive information externally, while simultaneously enabling pattern learning from both internal and external data sources. Furthermore, there is yet a need to harness the LLM's capabilities to tackle the complexity of predictive modeling and data analysis. Thus, while LLMs excel with text-based data, a system or a method is urgently needed to transform tabular data in a streamlined fashion, for example, for creating prompts for some of the leading LLMs to generate insights/predictions while safeguarding data privacy, while eliminating the need to share sensitive information externally and while still enabling pattern learning from both internal and external data sources.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 depicts a block diagram illustrating an artificial intelligence (AI)-based fraud detection system for monitoring alerts, in accordance with various embodiments.

FIG. 2 depicts a block diagram illustrating front end of data processing with respect to LLM fine-tuning and predictions used in fraud detection and alert monitoring, in accordance with various embodiments.

FIG. 3A illustrates a summary of an embedding, in accordance with various embodiments.

FIG. 3B illustrates an example embedding model, in accordance with various embodiments.

FIG. 4A depicts an example block diagram illustrating pre-training using prompts and completions, in accordance with various embodiments.

FIG. 4B an example block diagram illustrating a model training process, in accordance with various embodiments.

FIG. 5 depicts an example re-parameterization technique of Low-rank Adaptation (LoRA), in accordance with various embodiments.

FIG. 6A depicts a block diagram illustrating reinforcement learning using human feedback (RLHF), in accordance with various embodiments.

FIG. 6B depicts a plot comparing two models, in accordance with various embodiments.

FIG. 6C shows results in multiple formats, in accordance with various embodiments.

FIG. 7A depicts a system component diagram illustrating an artificial intelligence (AI)-based fraud detection system for monitoring alerts, in accordance with various embodiments.

FIG. 7B depicts a plot comparing Training and Test, in accordance with various embodiments.

FIG. 8A illustrates an alert prioritization flow, in accordance with various embodiments.

FIG. 8B depicts a block diagram 850 for predictive scoring, in accordance with various embodiments.

FIG. 9 depicts core groups illustrating an artificial intelligence (AI)-based fraud detection system for monitoring alerts, in accordance with various embodiments.

FIG. 10 is a block diagram of a computer system for an artificial intelligence (AI)-based fraud detection system for monitoring alerts, in accordance with various embodiments.

FIG. 11 is a flow chart for a method for training a machine learning (ML) model using a large language model (LLM), in accordance with various embodiments.

FIG. 12 is a flow chart for an artificial intelligence (AI)-based method for monitoring alerts, in accordance with various embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

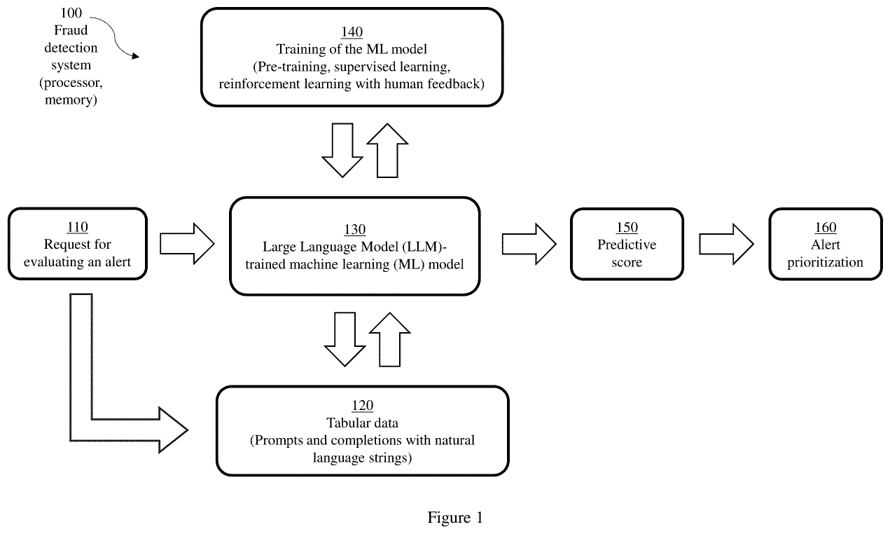

In accordance with various embodiments disclosed herein, an artificial intelligence (AI)-based fraud detection system for monitoring alerts is described in detail. The disclosed AI-based fraud detection system employs a method for monitoring alerts using a large language model (LLM)-trained machine learning (ML) model. The disclosed embodiments also include a method for training a ML model using an LLM. The disclosed approach proposes integrating LLMs into the training process to harness their capabilities while utilizing internal data. Since LLMs accept only text prompts as input, tabular data are transformed into narrative prompts, which can then be converted into embeddings, representing the latest features learned by the LLM during training. To further enhance efficiency, human feedback may be applied to improve the accuracy means in fine-tuning based on the human feedback using tuning algorithms, in accordance with one or more embodiments described herein. In other words, the disclosed system and method illustrate integrating LLMs into training specific machine learning models to harness vast capabilities of the LLMs. To demonstrate such embodiments, the disclosed system and methods illustrate the use of a small base model, such as LLAMA 2 7B, to fine tune the model on the generated prompts and completions for text prompts. In essence, the process flow of the disclosed technology may progress as follows—starting with a table of tabular data to generate prompts, which can be input into an LLM with textual embedding to create predictions, which can then be fine-tuned with human feedback to create better predictions. The disclosed system and methods are further described with respect to FIGS. 1-12, in accordance with various embodiments.

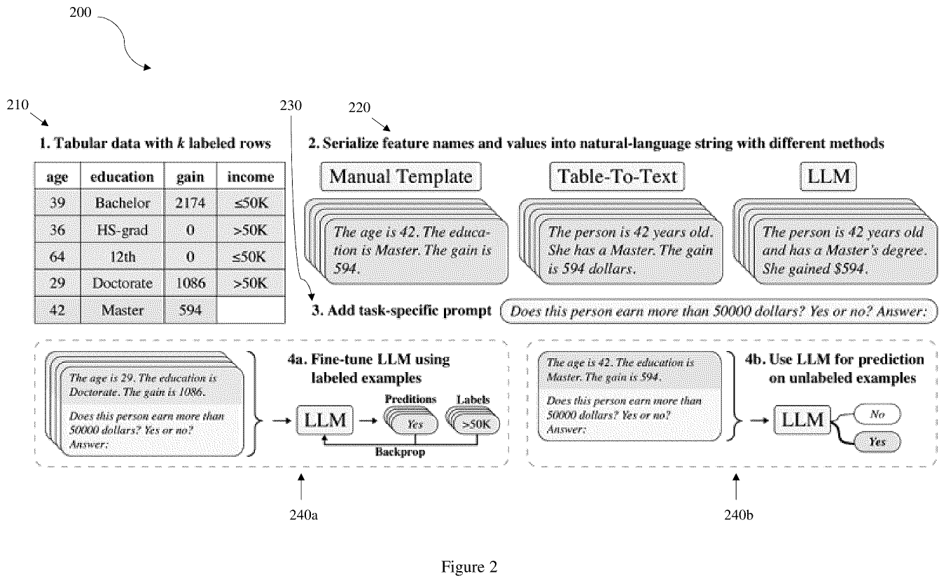

FIG. 1 depicts a block diagram illustrating an artificial intelligence (AI)-based fraud detection system 100 for monitoring alerts, in accordance with various embodiments. As illustrated in FIG. 1, the AI-based fraud detection system 100 may include a computer system, such as computer system 1000 as described below with respect to FIG. 1, having one or more processors and a non-transitory computer readable medium, e.g., a memory, operably coupled to the processor(s). The computer system/processor may be configured to execute instructions stored on the memory/non-transitory computer readable medium. The instructions may include a set of instructions to perform various alert analysis operations during alert monitoring. These operations, as further illustrated in various blocks of FIG. 1, may include, but not limited to, receiving a request, at block 110, for evaluating an alert to predict whether the alert warrants an investigation, where the alert may be associated with suspicious activities listed in tabular data, receiving the tabular data and converting the received tabular data, at block 120, into natural language strings for inputting into an LLM by creating prompts and completions from the tabular data, generating a predictive score, at block 150, via an LLM-trained machine learning (ML) model, at block 130, (e.g., the LLM-trained ML model is trained via a training program (can be referred to herein as a training system or a training method), at block 140, that includes, among many others, pre-training, supervised learning, and reinforcement learning with human feedback) based on the prompts and completions, where each prompt and its accompanying completion may be used as input into the LLM-trained ML model, wherein the predictive score indicates whether any of the suspicious activities warrant an investigation, comparing the predictive score to a threshold value for classification, and providing an alert prioritization, at block 160, based on the classification of the predictive score, in accordance with one or more embodiments disclosed herein. Various components, i.e., blocks, of FIG. 1 are described in further detail as follows with respect to FIGS. 2-12.

FIG. 2 depicts a block diagram 200 illustrating front end of data processing with respect to LLM fine-tuning and predictions used in fraud detection and alert monitoring, in accordance with various embodiments. As depicted in FIG. 2, block 210 illustrates tabular data with k labeled rows of data, which includes, for example, age, education level, gain and income of persons listed in the table. Block 220 illustrates serialized feature names and values that have been transformed from tabular data of block 210 into natural language strings with various methods, via a manual template, a table-to-text conversion and a string generated via an LLM. Block 230 of FIG. 2 further illustrates task-specific prompt that can be generated based on the information input data (e.g., from the tabular data and natural language strings). Using the combination of the input data and corresponding prompt, the LLM can be fine-tuned using these labeled examples, as shown in block 240a of FIG. 2. Block 240b illustrates that the combination of the input data and corresponding prompt can be used with an LLM for prediction of unlabeled examples. Additional details of data processing for fraud detection and alert monitoring are described below.

Data Collection Step: Extracting and finalizing features to use for the predictive model are described below by way of example. The extracted features may be categorical or numerical, in accordance with one or more embodiments. Table 1 below lists sample data with mixed columns, where each alert is tagged as issue or non-issue.

TABLE 1
Data columns (total 12 columns):

| # | Column | Non-Null Count | Dtype |
|---|---|---|---|
| 0 | person_age | 1740 non-null | int64 |
| 1 | person_income | 1740 non-null | int64 |
| 2 | person_home_ownership | 1740 non-null | object |
| 3 | person_emp_length | 1740 non-null | float64 |
| 4 | loan_intent | 1740 non-null | object |
| 5 | loan_grade | 1740 non-null | object |
| 6 | loan_amnt | 1740 non-null | int64 |
| 7 | loan_int_rate | 1740 non-null | float64 |
| 8 | loan_status | 1740 non-null | int64 |
| 9 | loan_percent_income | 1740 non-null | float64 |
| 10 | cb_person_default_on_file | 1740 non-null | object |
| 11 | cb_person_cred_hist_length | 1740 non-null | int64 |

dtypes: float64(3), int64(5), object (4)

Narrative Generation Step: Once the data is finalized and preprocessed, narratives can be generated, in accordance one or more embodiments. Since leading LLMs require input of data in the form of text, each row of data is converted into a form of narrative (e.g., a text string). In one or more embodiments, the tabular data, e.g., rows of data, are first converted into “json” format, which is then converted into narratives that can be input into an LLM. An example of conversion (from “RAW” data into “Narrative” data) is shown below in Table 2.

TABLE 2
Raw : {‘person_age’: 22, ‘person_income’: 70000, ‘person_home_ownership’: ‘RENT’,
‘person_emp_length’: 4.0, ‘loan_intent’: ‘EDUCATION’, ‘loan_grade’: ‘C’, ‘loan_amnt’:
27500, ‘loan_int_rate’: 13.06, ‘loan_percent_income’: 0.39, ‘cb_person_default_on_file’:
‘Y’, ‘cb_person_cred_hist_length’: 3}
Narrative: “The person is 22 years old, with an income of $70,000, and they rent their
home. They have been employed for 4 years. The loan they are applying for is for
education purposes, with a grade of C. The loan amount is $27,500 with an interest rate
of 13.06%. The loan represents 39% of their income. They have a default record on file
and their credit history is 3 years.”

Once the narrative is generated from the above steps, it may be stored in a JSON storage.

Getting Embeddings from the Narratives: In this step, the generated narratives are input into an LLM one at a time, via an application programming interface (API) of the LLM, for converting into embeddings. A vector database is then chosen to store the generated embeddings. These embeddings are used to convert the text data into a numerical format since LLMs accept data in numerical format only. An example code is shown below in Table 3.

TABLE 3

```
Code:
def get_embedding(text_to_embed):
  # Embed a line of Narrative
  response = openai.Embedding.create (
  model= “text-embedding-ada-002”,
  input=[text_to_embed]
  )
  # Extract the AI output embedding as a list of floats
  embedding = response[“data”][0][“embedding”]
  return embedding
```

The example code shown in Table 3 is a function called get_embedding that takes a narrative text_to_embed as input. The function uses the API, for example, for OpenAI, to embed the input text using a pre-trained language model called “text-embedding-ada-002”. The API call returns a response object, which contains the embedded representation of the input text as a list of floats. The function extracts this embedding from the response object and returns it as the output of the function. Overall, this code is a wrapper around the OpenAI API for text embedding, allowing for easy embedding of text using a pre-trained language model. The output includes the vectors of float number as shown in Table 4 below.

TABLE 4
starting embedding 0

[−0.014714154414832592, −0.0023064371198415756, 0.018150942400097847, −0.05012743920087814,
0.004531201906502247, −0.0132113
76965045929, −0.024410339072346687, 0.01400850247591734. −0.0368768610060215,
−0.026475023478269577, 0.006563218776136637,
0.021744541823863983, −0.011499516665935516, −0.009826860390603542, −0.0019193085609003901,
0.016582826152443886, 0.0194690
841138363, −0.02914082072675228, 0.021025821566581726, −0.02830449305474758,
−0.035857584327459335, 0.0035478624049574137,
0.03719048202037811, −0.006769034080207348, −0.0017641304293647408, −0.02209736779332161,
0.015119251795113087, −0.002105522
435158491, 0.012786678969860077, −0.016556691378355026, 0.02383536286652088,
−0.009911799803376198, −0.012623333372175694,
0.011989553458988667, −0.034289468079805374, −0.001565665821544826, −0.01673963852226734,
0.012440386228263378, 0.0086050359
53223705, −0.010310362093150616, 0.022371787577867508, −0.0030398580711334944,
−0.0072329347021877766, −0.01494937203824520

The size of the embedding vector may vary depending on the LLM used. For example, the embedding size used in this example is around 1500.

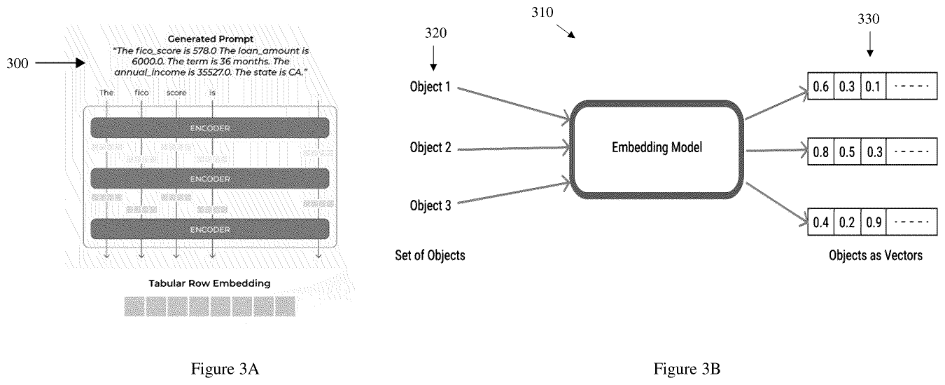

FIG. 3A illustrates a summary of an embedding 300, in accordance with various embodiments. FIG. 3B illustrates an example embedding model 310, in accordance with various embodiments. As illustrated in FIG. 3B, a machine learning (ML) algorithm ingests numbers in a form of a dataset with columns of numeric values or values that can be translated into ordinal, categorical, etc. In one or more embodiments, documents of text, e.g., objects 320 (object 1, object 2, object 3) shown in FIG. 3B, may be transformed into vector embeddings, e.g., objects as vectors 320, which are lists of numbers to perform various operations with them. Thus, a whole paragraph of text or any other object may be reduced to a vector as shown in FIG. 3B, in accordance with one or more embodiments. In some embodiments, numerical data can be turned into vectors for easier operations.

Prompt and Completion Generation: Data used for fine-tuning are to be converted into a form of prompt and completion. The specific prompt and completion used can vary depending on the task for which a generic LLM model, such as LLAMA 2 7B, is be fine-tuned. In one or more embodiments, 60,000 prompts are generated on 10,000 data points. Table 5 below shows original tabular data used in this example.

TABLE 5
Tabular dataset with information about employees:

| Employee ID | Name | Department | Salary |
|---|---|---|---|
| 001 | John Doe | HR | 50000 |
| 002 | Jane Smith | IT | 60000 |
| 003 | Bob Brown | Finance | 55000 |
| . . . | . . . | . . . | . . . |

Below are four example prompts and completions that are generated. More prompts and completions are better.
1. Prompt:
   1. “Given the following employee data: Employee ID, Name, Department, Salary. Please predict the department of an employee based on their name.”
   2. Completion Example:
      1. Input: “Name: John Doe”
      2. Output: “Department: HR”
2. Prompt:
   1. “Use the employee dataset to generate a summary of the average salary for each department.”
   2. Completion Example:
      1. Input: “Calculate average salary by department”
      2. Output: “HR: 50000, IT: 60000, Finance: 55000”
3. Prompt:
   1. “Given a list of employees and their salaries, predict the salary of a new employee based on their department.”
   2. Completion Example:
      1. Input: “Department: IT”
      2. Output: “Predicted Salary: [model-generated value]”
4. Prompt:
   1. “Perform a data transformation to add a new column ‘Bonus’ to the employee dataset, calculated as 10% of the salary.”
   2. Completion Example:
      1. Input: “Add Bonus column”
      2. Output: “New dataset with ‘Bonus’ column added”

Fine Tuning Model using human preference: LLAMA 2 7B model is used in this example. LLAMA 2 is a family of pre-trained and fine-tuned large language models (LLMs) released by Meta AI in 2023. These LLMs are released free of charge for research and commercial use, LLAMA 2 AI models are capable of a variety of natural language processing (NLP) tasks, from text generation to programming code.

To fine-tune a base LLAMA model, by way of example, the training process is divided into three core steps: 1) pre-training an LLM, 2) gathering data and training a reward model, and 3) fine-tuning the LLM with reinforcement learning using Proximal Policy Optimization (PPO).

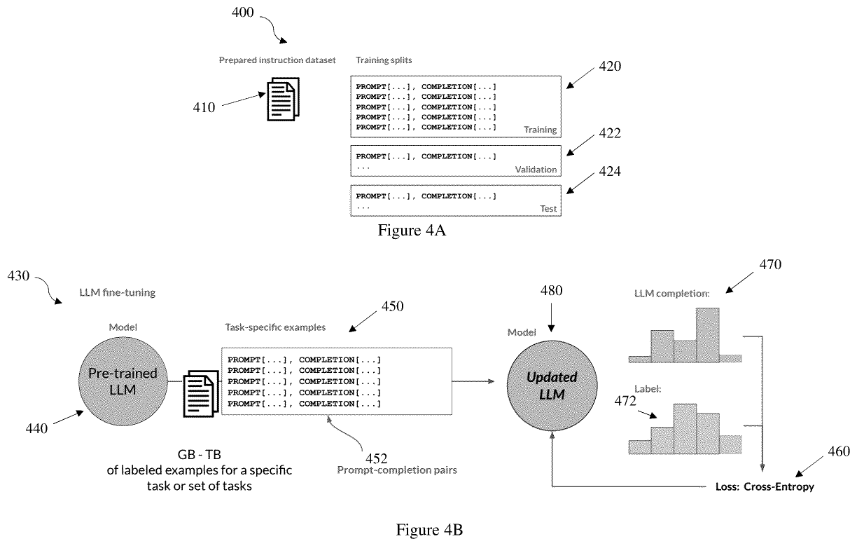

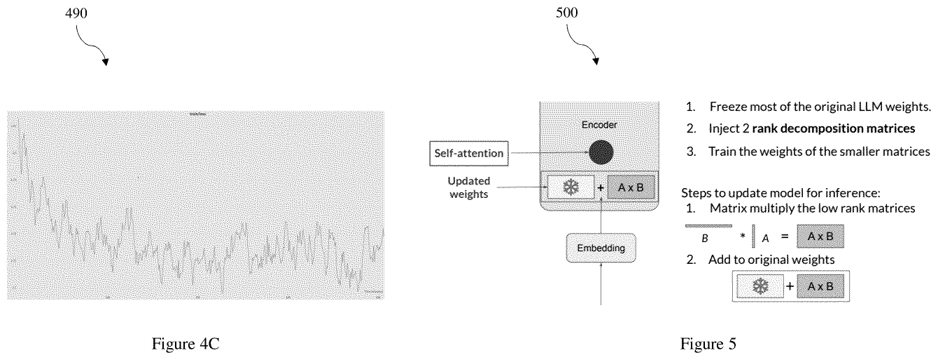

Step 1: Pre-training can be performed using prompt & completion generation as discussed above. FIG. 4A depicts an example block diagram illustrating a pre-training process 400 using prompts and completions, in accordance with various embodiments. As illustrated in FIG. 4A, the pre-training process 400 includes having a prepared instruction set 410 that can used in training 420, validation 422, and testing 424, in accordance with one or more embodiments.

Step 2: Model training: The LLM fine-tuning process typically involves feeding task-specific dataset to the pre-trained model and adjusting its parameters through backpropagation. FIG. 4B depicts an example block diagram illustrating a model training process 430, in accordance with various embodiments. In one or more embodiments, the goal of the model training is to minimize the model's loss function, which measures the difference between the model's predictions and the ground-truth labels in the dataset. As illustrated in FIG. 4B, the model training process 430 includes using a pre-trained LLM 440 to train with GB-TB of labeled examples of a specific task or a set of tasks, e.g., task-specific examples 450 that include a plurality of prompt-completion pairs 452. The model training process 430 further includes using a loss function 460 (e.g., Cross-Entropy loss function) between the LLM completion 470 and Label 472 to optimize and update the LLM to arrive at an updated LLM 480, as illustrated in FIG. 4B. In one or more embodiments, a custom script is written to compare accuracy, calculate precision and to perform predictive tasks.

FIG. 4C depicts a graph 490 illustrating a loss function as a function of time, in accordance with various embodiments. As depicted in FIG. 4C, the graph 490 shows that the loss is decreasing over time.

Step 3: Fine-tuning base LLM model using LoRA-parameter-efficient fine-tuning: Low-rank Adaptation (LoRA) is a re-parameterization technique in parameter-efficient fine-tuning is used in fine-tuning of the LLM. FIG. 5 depicts an example re-parameterization technique (LoRA technique) 500, in accordance with various embodiments. As depicted in FIG. 5, the LoRA technique 500 reduces the number of parameters during fine-tuning by introducing rank decomposition matrices alongside the original weights. This method involves freezing the original model parameters, training the low-rank matrices, and combining them with the frozen weights for inference, leading to a fine-tuned model with significantly fewer trainable parameters, in accordance with one or more embodiments herein. In LoRA technique 500, the rank of the low-rank matrices is chosen strategically to strike a balance between parameter reduction and model performance, in one or more embodiments. By applying LoRA to specific components, particularly the self-attention layers, a substantial reduction in trainable parameters can be achieved, leading to efficient fine-tuning, in one or more embodiments, as shown in Table 6 below.

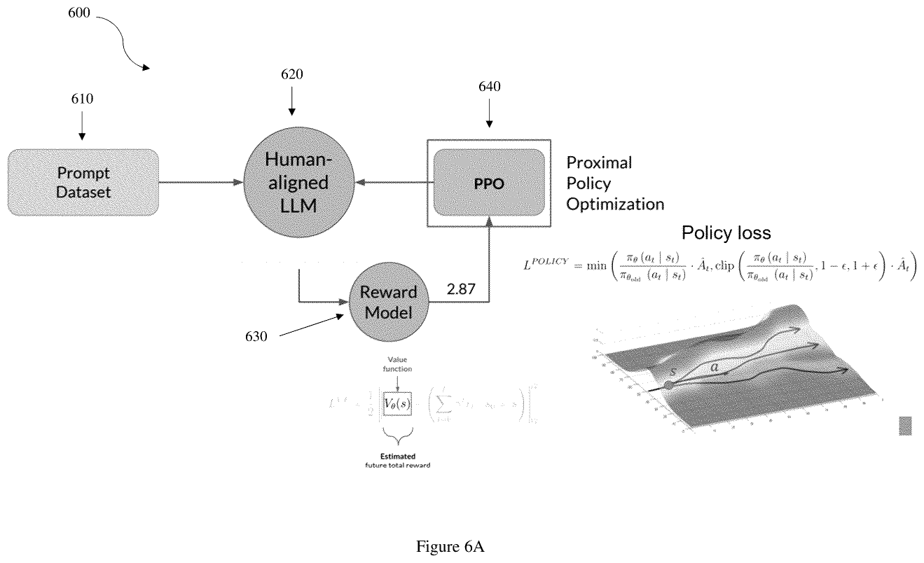

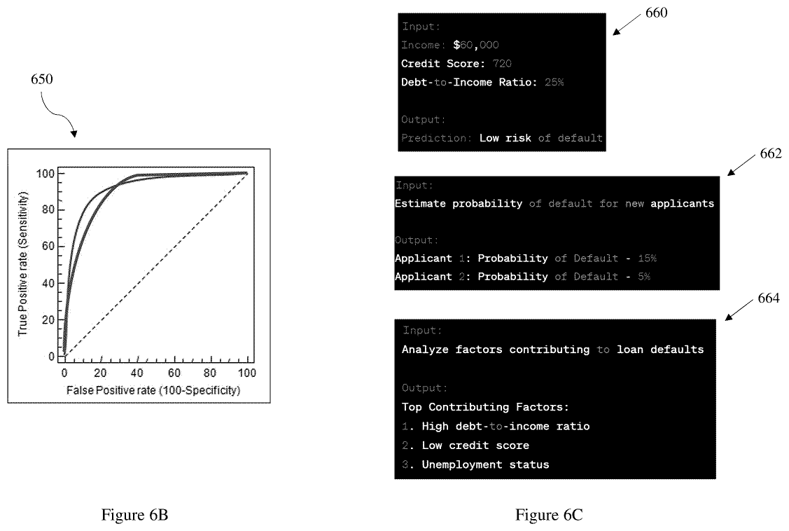

Step 4: Further fine-tuning using reinforcement learning using human feedback (RLHF): Human input is used to implement RLHF. FIG. 6A depicts a block diagram illustrating reinforcement learning using human feedback (RLHF) 600, in accordance with various embodiments. As depicted in FIG. 6A, the RLHF 600 is a model training procedure that is applied to a fine-tuned language model to further align model behavior with human preferences and instruction following. When a prompt dataset 610 is input into human-aligned LLM 620, data representing empirically sampled human preferences are collected so that human annotators can select which of two model outputs they prefer. This human feedback is subsequently used to train a reward model 630, which learns patterns in the preferences of the human annotators and can then automate preference decisions. As further illustrated in FIG. 6A, reward models are created to fine-tune models, e.g., via Proximal Policy Optimization (PPO) 640, which utilizes a policy loss function. In one or more embodiments, a reward model maybe designed to output a reward score for the optimization subsequent stage. This reward model generally originates from the LLM created in the prior supervised fine-tuning step. To turn the model from supervised fine-tuning into a reward model, its output layer (the next-token classification layer) is substituted with a regression layer, which features a single output node. The reward model is then trained on the collected human preference data to predict the reward scores accurately. Use the reward model to fine-tune the previous model from supervised fine-tuning by applying the PPO or a similar reinforcement learning algorithm, thereby optimizing the policy based on the reward signal to better align the model's behavior with human preferences.

Model performance: After model development, it is generally important to evaluate the model using specific parameters. The standard metrics are typically used for checking the performance of the model using LLM based features. In one example of evaluating the model, 60,000 prompts and completion are used with 10,000 records. Modelling steps are performed, for example, on a 24GB NVIDIA 4090 GPU. While it is possible to perform the entire training run on a 24 GB GPU, the full training runs can be untaken on a single A100 on the hugging face research cluster. Running the updated LLM model to get the final accuracy, which is, e.g., 0.825287356. And model development time may be reduced by 50-60%.

FIG. 6B depicts a plot 650 comparing two models, in accordance with various embodiments. The plot 650 compares two models on receiver operating characteristic (ROC) curve, which is a graphical plot that illustrates the performance of a binary classifier model at varying threshold value, based on the area under the ROC curve (AUC) values. As shown in the plot 650, the base model provides around 0.93 of AUC value and the LLM-based model is around 0.92 of AUC value. A major difference is that they are not related to feature engineering and preprocessing in the LLM approach. Other findings include model development time being reduced by 70-80%. The model becomes more robust since it provides more accurate prediction without providing full data, with decent accuracy and promising results without any preprocessing and engineering. In turns, the model can provide more accurate results with additional effort on providing narrative generation according to the disclosure, which can then be tested on other samples, with results ranging from 10 to 20% less than the highest score achieved on Kaggle. The results are shown in FIG. 6C in multiple formats 660, 662, and 664.

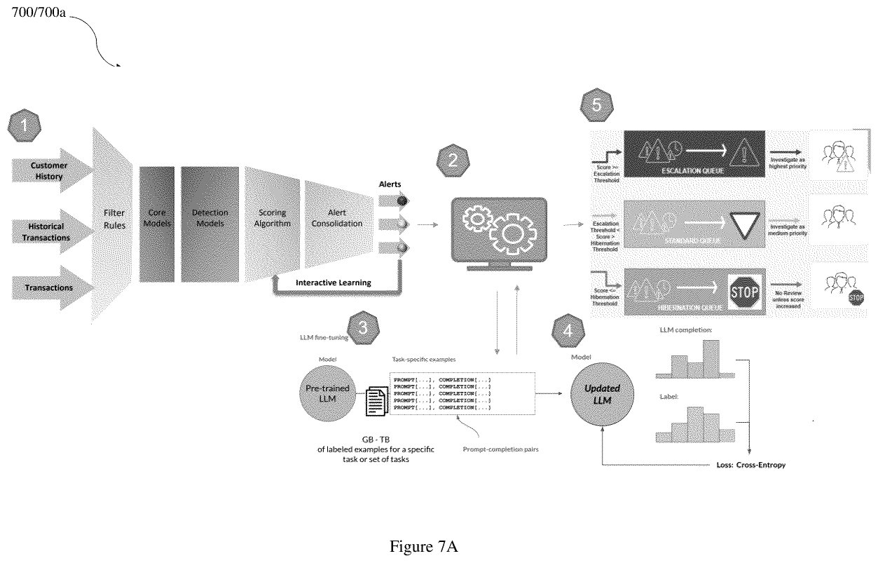

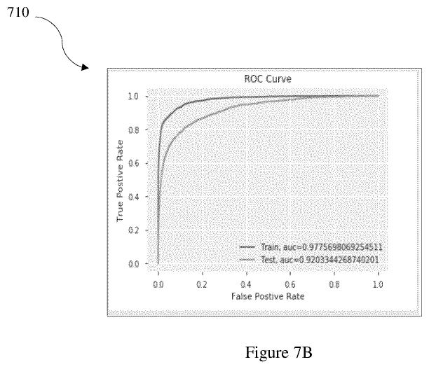

FIG. 7A depicts a system component diagram 700a illustrating an artificial intelligence (AI)-based fraud detection system 700 for monitoring alerts, in accordance with various embodiments. In one or more embodiments, the system component diagram 700a is depicted with reference to a suspicious activity monitoring (SAM) predictive model. The SAM predictive model takes the alert information and give score to each alert, after which score will be used for the ranking of the Alerts into three buckets escalation/standard/hibernation. The three buckets are further defined as follows: Escalation: No false positive and mostly true positives; Standard: High score true positive and some false positives as well; and Hibernation: No true positive only false positives, so that investigator can more easily close this kind of alert.

The various components and the flow of the system components are described as follows:
1. Run the rules and generate: Alerts on the SAM system provide alert for the predictive model. Data contains static and transactional data for the entities. Depending on the sparsity, some features are chosen, and the chosen features are used for the training the predictive model and to validate the results.
2. Alerted data pass to model but before passing: The model cleans and preprocesses the data so that noise in the data can be minimized. Table 7 below shows snapshot of data used in the model.

TABLE 7

| Description Id | Feature |
|---|---|
| Actimize.Watch.Feature.ACCOUNT_TYPE_CD_REVOLVING CONSUMER | ACCOUNT_TYPE_CD_REVOLVING CONSUMER |
| Actimize.Watch.Feature.ACCT_CURR_CREDIT_LIMIT_BINS_MEDIUM | ACCT_CURR_CREDIT_LIMIT_BINS_MEDIUM |
| Actimize.Watch.Feature.SAM_POPULATION_GROUP_CD_PLCC | SAM_POPULATION_GROUP_CD_PLCC |
| Actimize.Watch.Feature.REGION_CD | REGION_CD |
| Actimize.Watch.feature.ACCT_CURR_CREDIT_LIMIT_BINS_HIGH | ACCT_CURR_CREDIT_LIMIT_BINS_HIGH |
| Actimize.Watch.Feature.ACCOUNT_CLASSIFICATION_CD_PLCC | ACCOUNT_CLASSIFICATION_CD_PLCC |
| Actimize.Watch.Feature.AML-FRP-CRP-INN-A-M01- | AML-FRP-CRP-INN-A-M01-FRT#S_{—} |
| FRT#S 2.102.1#MAX CALC_SCORE | 2.102.1#MAX_CALC SCORE |
| Actimize.Watch.Feature.ACCOUNT_STATUS_CD_E | ACCOUNT_STATUS_CD_E |
| Actimize.Watch.Feature.SYF-HBC-CRP-INN- | SYF-HBC-CRP-INN-A-M01- |
| A-M01-HBN#S_1.107.1#AVG_CALC SCORE | HBN#S_1.107.1#AVG_CALC_SCORE |
| Actimize.Watch.Feature.SYF-HBC-CRP-INN-A-M01- | SYF-HBC-CRP-INN-A-M01-HBN#S_{—} |
| HBN#S_1.107.1#MAX_CALC_SCORE | 1.107.1#MAX_CALC_SCORE |
| Actimize.Watch.Feature.AML-FRP-CRP-INN- | AML-FRP-CRP-INN-A-M01- |
| A-M01-FRTAS_1.101.1#MIN_CALC_SCORE | FRT#S_1.101.1#MIN_CALC_SCORE |
| Actimize.Watch.Feature.ACCOUNT_STATUS_CD_MISSING | ACCOUNT_STATUS_CD_MISSING |
| Actimize.Watch.Feature.HIGHFOCUSSISUETYPE#SUM_{—} | HIGHFOCUSSISUETYPE#SUM_{—} |
| SCORE_BY_ISSUE_TYPE | SCORE_BY_ISSUE_TYPE |

3. Model will collect all the data and convert into narratives and fine tunned base model: Once the data is finalized and preprocessed, the next step is the narrative generation. Since LLM requires input in the form of text only, one format is decided to be used and convert each row of data into in a form of narrative.
4. Improve using reinforcement learning by proximal policy Optimization: To implement RLHF, first human input is needed. As the LLAMA paper states, this can be done by giving humans different options which they can rank. RLHF is a model training procedure that is applied to a fine-tuned language model to further align model behavior with human preferences and instruction following. Collected data represents empirically sampled human preferences, whereby human annotators select which of two model outputs they prefer. This human feedback is subsequently used to train a reward model, which learns patterns in the preferences of the human annotators and can then automate preference decisions. Next reward models are created to fine-tune models, e.g., via Proximal Policy Optimization (PPO). A reward model is designed to output a reward score for the optimization subsequent stage. This reward model generally originates from the LLM created in the prior supervised fine-tuning step. To turn the model from supervised fine-tuning into a reward model, its output layer (the next-token classification layer) is substituted with a regression layer, which features a single output node. The reward model is then trained on the collected human preference data to predict the reward scores accurately. Use the reward model to fine-tune the previous model from supervised fine-tuning by applying the PPO or a similar reinforcement learning algorithm, thereby optimizing the policy based on the reward signal to better align the model's behavior with human preferences.
5. Based on the model output alerts are categorized into three buckets for further investigation: After running the model, the alert score is received for each alert and to understand and assess how the model is performing on test samples (unseen data), different metrics and techniques are used. Table 8 below shows precision results based on TPs and FPs for Train and Test.

TABLE 8

| Dataset | TP Alerts | FP Alerts | Total Alerts | Precision |
|---|---|---|---|---|
| Training | 2,656 | 70,114 | 72,770 | 3.65% |
| Test | 664 | 17,529 | 18,193 | 3.65% |
| TOTAL | 3,320 | 87,643 | 90,963 | 3.65% |

FIG. 7B depicts a plot 710 comparing Training and Test, in accordance with various embodiments. The AUC results of the Training and Test are shown in Table 9 below.

TABLE 9

| Dataset | AUC |
|---|---|
| Training | 97% |
| Test | 92% |

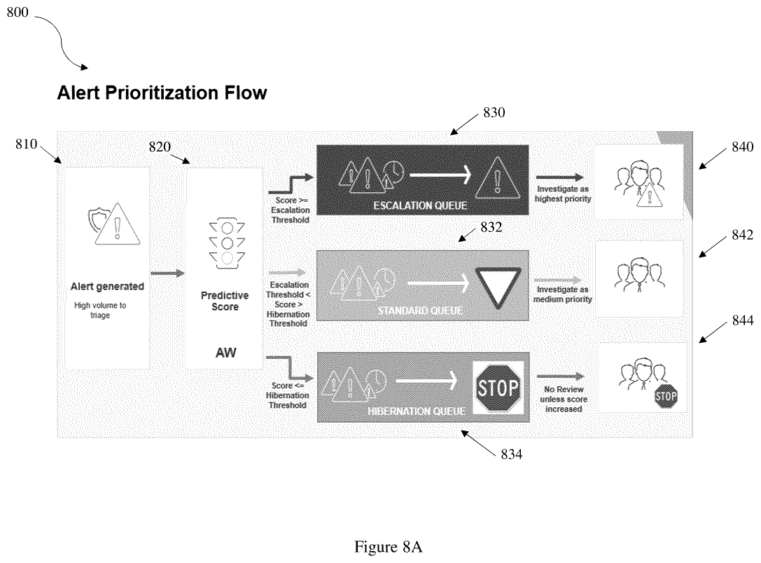

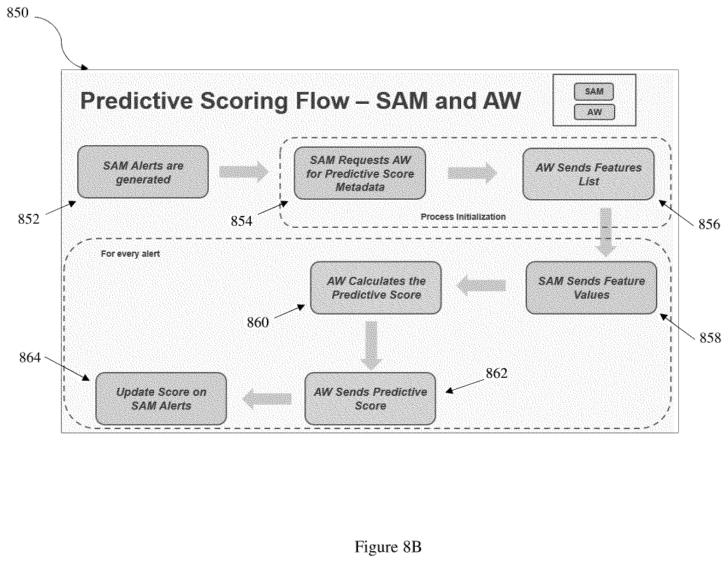

FIG. 8A illustrates an alert prioritization flow 800, in accordance with various embodiments. As illustrated in FIG. 8A, the alert prioritization flow 800 receives at the generated alert at block 810, which is used to generate a predictive score at block 820. In other words, an output of the predictive algorithms in the alert prioritization flow 800 is probability/predictive score. The scores are arranged in descending order to rank. Alert associated with high rank are sent in for the further investigation. For example, the alert is ranked based on the ranking, and then prioritized into three buckets, i.e., escalation queue at block 830, standard queue at block 832, and hibernation queue at block 834, and sent to an investigator based on investigation results, respectively, as highest priority at block 840, medium priority at block 842, and no investigation/review unless score increased at block 844, as illustrated in FIG. 8A.

In some embodiments, the result of the predictive model algorithms is a probability value which helps to prioritize the alert. Alert is set if one or more transactions are responsible for the suspicious behavior of the parties. Based on the output of the predictive algorithm in the alert prioritization flow 800, the scores are ranked to take some action based on the alert. Since some alerts based on the score appear less vulnerable, they are included into the hibernation bucket, but the other alerts are bucketed into the standard to escalation bucket where action may be taken, for example, to suspend the account and/or alert for investigation on the transactions done by such party. In one embodiment, the alert of the escalation queue at bucket 840 is sent into suspicious activity report (SAR) generation, indicating that the party is found guilty so their transaction and account may be suspended.

### Model Outputs, Reports & Uses

Using the model's probability score, alerts are prioritized, and the routing is performed as shown in Tables 10 and 11 below.

TABLE 10

| Categories | Classification | Alert % (example) |
|---|---|---|
| Escalation | SAR preparation | Top 1% alerts (highest scores) |
| | Level 2 investigation | Next~9% alerts |
| Standard | Level 1 investigation | Next~60% alerts |
| Hibernate | Hibernate | Bottom 30% alerts (lowest |
| | | scores) |

Table 11 shows the Alert prioritization, i.e., the final classification of Alerts based on the Predictive score. Table 11 (1 or 2) shows left-most columns and Table 11 (2 of 2) shows right-most columns.

TABLE 11

| | | | True | False | Training Data | |
|---|---|---|---|---|---|---|
| | Min | Max | True | False | TP | FP |
| Percentile | Score | Score | Positives | Positives | Rate | Rate |
| 0 | 0.8138424 | 0.9987888 | 728 | 0 | 27.41% | 0.00% |
| 1 | 0.5642257 | 0.8137472 | 644 | 84 | 24.25% | 0.12% |
| 2 | 0.3297857 | 0.5641016 | 441 | 287 | 16.60% | 0.41% |
| 3 | 0.1912434 | 0.3291938 | 273 | 454 | 10.28% | 0.65% |
| 4 | 0.119463 | 0.1904296 | 121 | 607 | 4.56% | 0.87% |
| 5 | 0.0863356 | 0.1194551 | 52 | 676 | 1.96% | 0.96% |
| 6 | 0.0687063 | 0.0862821 | 42 | 685 | 1.58% | 0.98% |
| 7 | 0.0574321 | 0.0686005 | 35 | 693 | 1.32% | 0.99% |
| 8 | 0.0509401 | 0.0574126 | 38 | 690 | 1.43% | 0.98% |
| 9 | 0.0482381 | 0.0509381 | 8 | 386 | 0.30% | 0.55% |
| 10 | 0.023956 | 0.0482323 | 186 | 7424 | 7.00% | 10.59% |
| 20 | 0.013745 | 0.0239576 | 49 | 7228 | 1.84% | 10.31% |
| 30 | 0.008802 | 0.013745 | 18 | 7259 | 0.68% | 10.35% |
| 40 | 0.005707 | 0.008802 | 8 | 7271 | 0.23% | 10.37% |
| 50 | 0.003704 | 0.005707 | 8 | 7269 | 0.23% | 10.37% |
| 60 | 0.002503 | 0.003704 | 4 | 7273 | 0.15% | 10.37% |
| 70 | 0.00179 | 0.002503 | 1 | 7276 | 0.04% | 10.38% |
| 80 | 0.00111 | 0.00179 | 2 | 7275 | 0.08% | 10.38% |
| 90 | 0.000026 | 0.00111 | 0 | 7277 | 0.00% | 10.38% |
| Totals | | | 2656 | 70114 | | |

| | Cumulated | Cumulated | | | | |
|---|---|---|---|---|---|---|
| | Cumulated | Cumulated | | | | |
| FP Rate | TP Rate | FP Rate | KS | Classification | Alert % | Precision |
| 0.00% | 27.41% | 0.00% | 27.4 | SAR | 1.00% | 100.00% |
| | | | | Preparation | | |
| 0.12% | 51.66% | 0.12% | 51.5 | Level 2 | 8.54% | 26.61% |
| | | | | Investigation | | |
| 0.41% | 68.26% | 0.53% | 67.7 | | | |
| 0.65% | 78.54% | 1.18% | 77.4 | | | |
| 0.87% | 83.09% | 2.04% | 81.1 | | | |
| 0.96% | 85.05% | 3.01% | 82.0 | | | |
| 0.98% | 86.63% | 3.98% | 82.7 | | | |
| 0.99% | 87.95% | 4.97% | 83.0 | | | |
| 0.98% | 89.38% | 5.96% | 83.4 | | | |
| 0.55% | 89.68% | 6.51% | 83.2 | | | |
| 10.59% | 96.69% | 17.10% | 79.6 | Level 1 | 60.46% | 0.62% |
| | | | | Investigation | | |
| 10.31% | 98.53% | 27.40% | 71.1 | | | |
| 10.35% | 99.21% | 37.76% | 61.5 | | | |
| 10.37% | 99.44% | 48.13% | 51.3 | | | |
| 10.37% | 99.67% | 58.49% | 41.2 | | | |
| 10.37% | 99.82% | 68.87% | 31.0 | | | |
| 10.38% | 99.86% | 79.25% | 20.7 | | | |
| 10.38% | 99.94% | 89.62% | 10.4 | Hibernate | 30.00% | 0.01% |
| 10.38% | 100.00% | 100.00% | 0.0 | | | |

FIG. 8B depicts a block diagram 850 for predictive scoring, in accordance with various embodiments. As depicted in FIG. 8B, the block diagram 850 shows how information flows and interact with various entities, for example, how predictive scoring occurs within the disclosed embodiments.

SAM Alert generation at block 852: Within suspicious activity monitoring (SAM) and Actimize watch (AW), SAM generates the alert and sends it to AW for the model training and prediction.

SAM requests AW for Predictive Score Metadata at block 854: SAM requests metadata, which is to send relevant data to AW for predictive scoring.

AW Sends Feature list at block 856: AW reverts with it which contain the feature list for the model prediction with correct data type and logic to get the data from the SAM systems.

SAM Sends feature values at block 858: After receiving the feature list from AW, SAM sends back the features with its value for which predictive scoring is to happen.

AW Calculates the Predictive Score at block 860: Once the features and their data are received from SAM system, the information is sent to model building to generate the alert score or predictive score.

AW Sends Predictive Score at block 862: The alerts will be bucketed into 3 categories as per score i.e., escalation queue, general/standard queue, and hibernation queue.

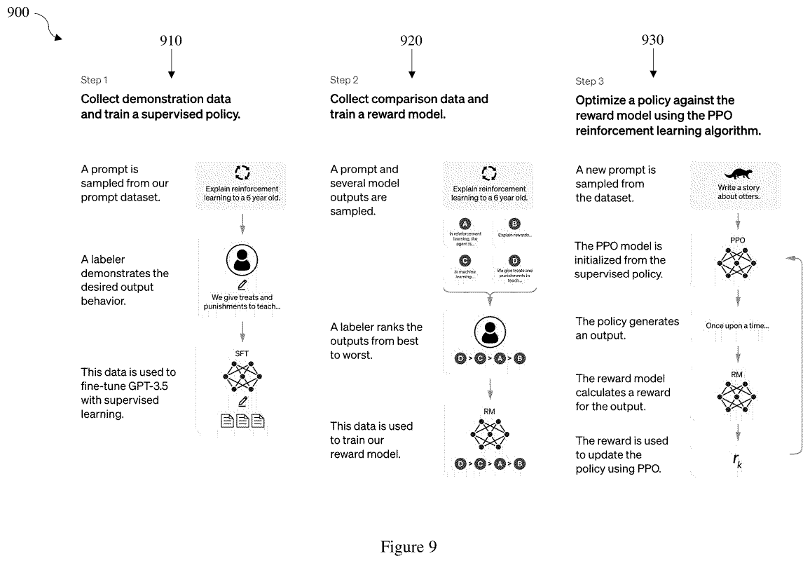

Update Score on SAM Alerts at block 864: The result is sent back to SAM so that they can display it in the designer as shown below in FIG. 9.

In accordance with one or more embodiments, the block diagram 850 describes the development process for a predictive scoring model designed to prioritize alerts generated from the SAM environment. In one embodiment, the object is to streamline the investigation process by focusing on alerts with a higher likelihood of being legitimate issues.

FIG. 9 depicts core groups illustrating an artificial intelligence (AI)-based fraud detection system 900 for monitoring alerts, in accordance with various embodiments. As depicted in FIG. 9, the system 900 includes a group 910 for collecting demonstration data and to train a supervised policy, a group 920 for collecting comparison data and to train a reward model, and a group 930 for optimizing a policy against the reward model using the PPO reinforcement learning algorithm, in accordance with one or more embodiments.

### Model Functionality

The model employs a supervised machine learning algorithm, for example, CatBoost, to analyze alert data and predict the probability of each alert being a true positive (also referred to as a suspicious activity report (SAR) or an “Issue”). This score, along with an explanation, aids in prioritizing alerts for investigation.

### Model Development Flow

The development process can be broadly categorized into the following steps:
1. Model Framework and Data Attribute Availability: This initial step involves selecting an appropriate model framework and confirming the availability of relevant data attributes within your SAM-9 environment.
2. Data Extraction, Preparation, and Quality: Data is extracted from your SAM-9 environment and then undergoes preparation, including cleaning, transformation, and validation to ensure its quality and suitability for model training.
3. Feature Selection and Transformation: Key features (data points) that influence the model's prediction accuracy are identified and potentially transformed to improve their effectiveness.
4. Predictive Scoring Model Development: Using LLM model as a model framework, the framework includes the following steps:
   1) **Data Collection & Preprocessing:**
      Use tabular transaction data from SAM/WLXs.
      Feature engineer relevant features (categorical/numerical).
      Data is stored and fetched from S3.
   2) **Narrative Generation:**
      Convert data rows to text narratives for LLM input.
      Example: User info like age, income, loan details converted to a narrative.
      Narratives are stored in S3.
   3) **Embedding Generation:**
      Use OpenAI API to convert narrative text into numerical embeddings.
      Embeddings are stored in a vector database.
   4) **Prompt & Completion Generation:**
      Create prompts and completions (input-output pairs) for fine-tuning a generic LLM.
      Examples: Predicting department based on employee name, summarizing salaries.
   5) **Fine-Tuning Model:**
      Process involves 3 steps:
         Generate prompts & completions (covered in step 4).
         Train the model on task-specific data (minimizing loss function).
         Fine-tune using LoRA (reduces parameters) for efficiency.
   6) **Further Fine-Tuning with Human Feedback:**
      Use human feedback (ranking model outputs) to improve model performance.
      This is achieved through Reinforcement Learning using Human Feedback (RLHF).
5. Predictive Scoring Model Deployment: Once trained, the model is integrated into Actimize Watch (e.g., AWS cloud) environment, enabling it to score new incoming alerts.
6. Model Documentation: The entire development process is documented, including the methodologies applied and the rationale behind each step.

### Model Performance Evaluation

The model's performance is rigorously evaluated using Out-Of-Time testing data. This ensures the model generalizes well to unseen data. Various metrics, such as AUC-ROC, Precision, Recall, and F-Score, are employed to assess the model's effectiveness and stability across different data samples.

### Alert Prioritization

To prioritize alerts based on their predicted scores, a decile analysis and Kolmogorov-Smirnov (KS) statistic are used. This approach segments alerts into different categories based on their predicted probability of being true positives. Details on this prioritization method are provided in section 8 of the document.

### Continuous Improvement

Model development is an ongoing process. While the current approach leverages best-in-class techniques, the team continuously explores and evaluates alternative methods to guarantee the deployment of the most effective possible model and scoring system. The documentation outlines the plan for testing and incorporating future improvements based on ongoing research and experimentation.

### Adaptability

The specific steps involved in model development can vary depending on the nature of the data used and the problem statement. There's no single “one-size-fits-all” approach as data availability and its characteristics differ across clients. This document focuses on the recommended methodology endorsed by the data scientists after careful consideration of the specific data and challenges presented by a given SAM environment.

### Examples and Previous Client Considerations

Various projects have highlighted the importance of clear and relevant examples within the documentation. To address this, illustrative examples from past models are intentionally included throughout the document. These examples showcase the methodologies used in developing the model and aid in understanding the results. A dedicated section on “Documentation Design and Examples” is incorporated to further emphasize the importance of clear explanations and illustrations.

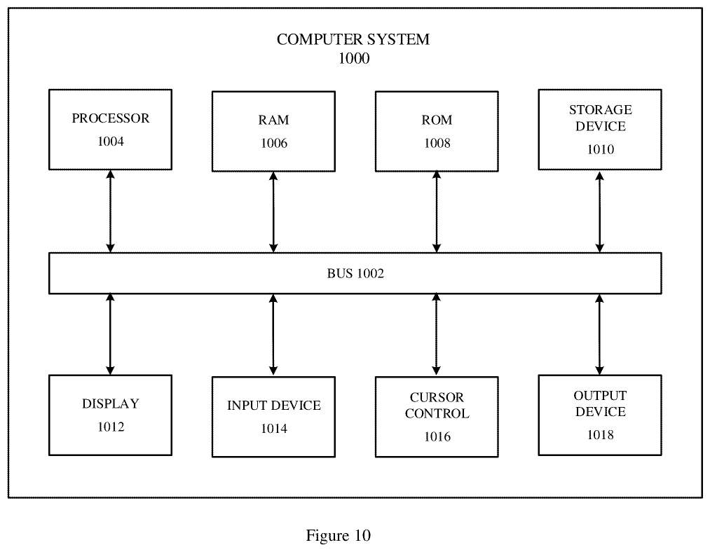

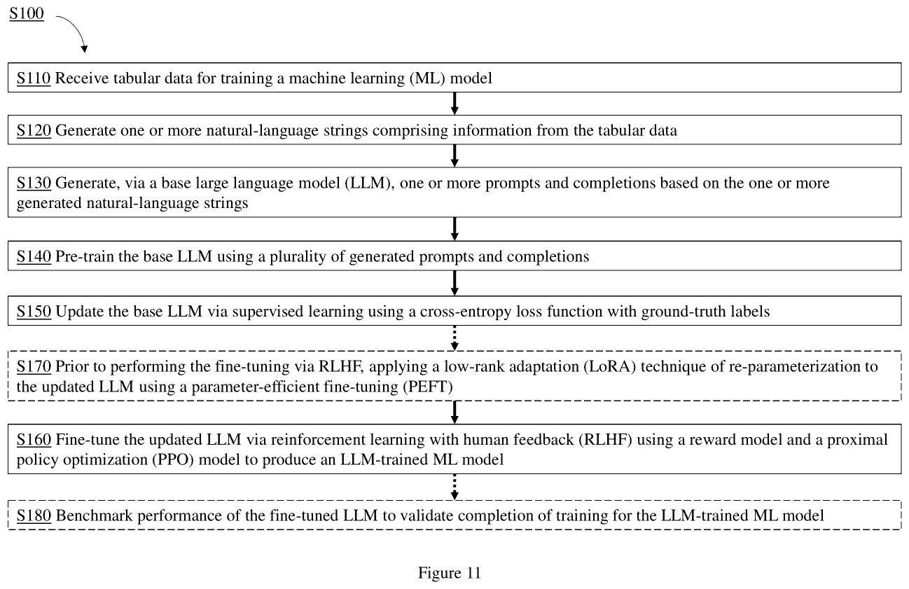

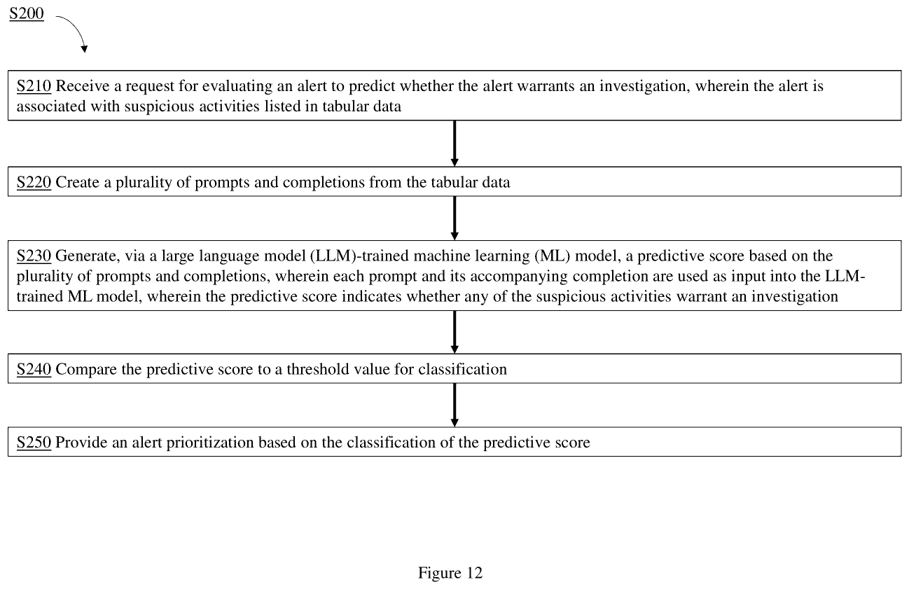

FIG. 10 is a block diagram of a computer system 1000 for an artificial intelligence (AI)-based fraud detection system for monitoring alerts, in accordance with various embodiments. The computer system 1000 may be an example of one implementation for various systems, such as the artificial intelligence (AI)-based fraud detection systems 100, 700, or 900, or the reinforcement learning using human feedback (RLHF) 600, or various processes described with respect to FIGS. 1-9, and methods, such as methods S100 and S200 as described below with respect to FIGS. 11 and 12.

In one or more examples, computer system 1000 can include a bus 1002 or other communication mechanism for communicating information, and a processor 1004 coupled with bus 1002 for processing information. In various embodiments, computer system 1000 can also include a memory, which can be a random-access memory (RAM) 1006 or other dynamic storage device, coupled to bus 1002 for determining instructions to be executed by processor 1004. Memory also can be used for storing temporary variables or other intermediate information during execution of instructions to be executed by processor 1004. In various embodiments, computer system 1000 can further include a read only memory (ROM) 1008 or other static storage device coupled to bus 1002 for storing static information and instructions for processor 1004. A storage device 1010, such as a magnetic disk or optical disk, can be provided and coupled to bus 1002 for storing information and instructions.

In various embodiments, computer system 1000 can be coupled via bus 1002 to a display 1012, such as a cathode ray tube (CRT), liquid crystal display (LCD), or light emitting diode (LED) for displaying information to a computer user. An input device 1014, including alphanumeric and other keys, can be coupled to bus 1002 for communicating information and command selections to processor 1004. Another type of user input device is a cursor control 1016, such as a mouse, a joystick, a trackball, a gesture input device, a gaze-based input device, or cursor direction keys, for communicating direction information and command selections to processor 1004 and for controlling cursor movement on display 1012. This input device 1014 typically has two degrees of freedom in two axes, a first axis (e.g., x) and a second axis (e.g., y), that allows the device to specify positions in a plane. However, it should be understood that input devices 1014 allowing for three-dimensional (e.g., x, y, and z) cursor movement are also contemplated herein.

Consistent with certain implementations of the present teachings, results can be provided by computer system 1000 in response to processor 1004 executing one or more sequences of one or more instructions contained in RAM 1006. Such instructions can be read into RAM 1006 from another computer-readable medium or computer-readable storage medium, such as storage device 1010. Execution of the sequences of instructions contained in RAM 1006 can cause processor 1004 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 1004 for execution. Such a medium can take many forms, including but not limited to, non-volatile media, volatile media, and transmission media. Examples of non-volatile media can include, but are not limited to, optical, solid state, magnetic disks, such as storage device 1010. Examples of volatile media can include, but are not limited to, dynamic memory, such as RAM 1006. Examples of transmission media can include, but are not limited to, coaxial cables, copper wire, and fiber optics, including the wires that comprise bus 1002.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 1004 of computer system 1000 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 1000 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 1000, whereby processor 1004 would execute the analyses and determinations provided by these engines, subject to instructions provided by any one of, or a combination of, the memory components RAM 1006, ROM, 1008, or storage device 1010 and user input provided via input device 1014.

FIG. 11 is a flow chart for method S100 for training a machine learning (ML) model using a large language model (LLM), in accordance with various embodiments. As illustrated in FIG. 11, the method S100 includes, at step S110, receiving tabular data for training the ML model; at step S120, generating one or more natural-language strings comprising information from the tabular data; at step S130, generating, via a base LLM, one or more prompts and completions based on the one or more generated natural-language strings; at step S140, pre-training the base LLM using a plurality of generated prompts and completions; at step S150, updating the base LLM via supervised learning using a cross-entropy loss function with ground-truth labels; and at step S160, fine-tuning the updated LLM via reinforcement learning with human feedback (RLHF) using a reward model and a proximal policy optimization (PPO) model to produce an LLM-trained ML model.

In one or more embodiments, pre-training the base LLM at step S140 may include feeding the plurality of generated prompts and completions to the base LLM, and adjusting the base LLM's parameters through backpropagation.

In one or more embodiments, updating the base LLM via the supervised learning at step S150 may include measuring a difference between the base LLM's predictions and the ground-truth labels to minimize the cross-entropy loss function, and updating the base LLM's parameters based on the measured difference.

In one or more embodiments, the method S100 may optionally include, at step S170, prior to performing the fine-tuning via RLHF, applying a low-rank adaptation (LoRA) technique of re-parameterization to the updated LLM using a parameter-efficient fine-tuning (PEFT). In one or more embodiments, applying the LoRA technique for PEFT may further include freezing original LLM weights, injecting 2 rank decomposition matrices, and/or training weights of smaller matrices.

In one or more embodiments, fine-tuning the updated LLM via RLHF at step S160 may include aligning behaviors of the updated LLM with human preferences via annotation with labels, recognizing preferred model outputs of the updated LLM in a pattern, and/or automating the fine-tuning of the updated LLM based on the recognized pattern. In one or more embodiments, the completions are provided by the base LLM, or another large language model, in response to the one or more prompts, and wherein each completion may include a query input and a query output.

In one or more embodiments, the method S100 may optionally include, at step S180, benchmarking performance of the fine-tuned LLM to validate completion of training for the LLM-trained ML model. In one or more embodiments, the benchmarking may include optimizing true positive rate (sensitivity) values versus false positive rate (specificity) for the LLM-trained ML model, and producing a chart or a plot displaying the benchmarked performance of the LLM-trained ML model.

In various embodiments, a system for detecting fraud may utilize the LLM-trained ML model according to the method S100.

In accordance with one or more embodiments, an artificial intelligence (AI)-based fraud detection system for monitoring alerts is provided. The system includes one or more processors and a non-transitory computer readable medium operably coupled thereto, the non-transitory computer readable medium comprising a plurality of instructions stored in association therewith that are accessible to, and executable by, the one or more processors, to perform alert analysis operations. The alert analysis operations performed by the AI-based fraud detection system may include receiving a request for evaluating an alert to predict whether the alert warrants an investigation, wherein the alert is associated with suspicious activities listed in tabular data; creating a plurality of prompts and completions from the tabular data; generating, via a LLM-trained ML model, a predictive score based on the plurality of prompts and completions, wherein each prompt and its accompanying completion are used as input into the LLM-trained ML model, wherein the predictive score indicates whether any of the suspicious activities warrant an investigation; comparing the predictive score to a threshold value for classification; and providing an alert prioritization based on the classification of the predictive score.

In one or more embodiments of the AI-based fraud detection system, the LLM-trained ML model may be trained using a library of training prompts and training completions. The training of the LLM-trained ML model may include pre-training a base LLM using the library of training prompts and training completions; updating the base LLM via supervised learning using a cross-entropy loss function with ground-truth labels; and fine-tuning the updated LLM via reinforcement learning with human feedback (RLHF) using a reward model and a proximal policy optimization (PPO) model to produce an LLM-trained ML model.

In one or more embodiments of the AI-based fraud detection system, updating the base LLM via the supervised learning may include measuring a difference between the base LLM's predictions and the ground-truth labels to minimize the cross-entropy loss function, and updating the base LLM's parameters based on the measured difference.

In one or more embodiments of the AI-based fraud detection system, the training of the LLM-trained ML model may further include, prior to performing the fine-tuning via RLHF, applying a low-rank adaptation (LoRA) technique of re-parameterization to the updated LLM using a parameter-efficient fine-tuning (PEFT), wherein applying the LoRA technique for PEFT may include freezing original LLM weights, injecting 2 rank decomposition matrices, and training weights of smaller matrices.

FIG. 12 is a flow chart for an artificial intelligence (AI)-based method S200 for monitoring alerts, in accordance with various embodiments. The method S200 may include additional or complementary processing steps compared to those of the method S100, in one or more embodiments. As shown in FIG. 12, the method S200 includes, at step S210, receiving a request for evaluating an alert to predict whether the alert warrants an investigation, wherein the alert is associated with suspicious activities listed in tabular data; at step S220, creating a plurality of prompts and completions from the tabular data; at step S230, generating, via a large language model (LLM)-trained machine learning (ML) model, a predictive score based on the plurality of prompts and completions, wherein each prompt and its accompanying completion are used as input into the LLM-trained ML model, wherein the predictive score indicates whether any of the suspicious activities warrant an investigation; at step S240, comparing the predictive score to a threshold value for classification; and at step S250, providing an alert prioritization based on the classification of the predictive score.

In one or more embodiments, the LLM-trained ML model of step S230 may be trained using a library of training prompts and training completions, and wherein the training of the LLM-trained ML model may include pre-training a base LLM using the library of training prompts and training completions; updating the base LLM via supervised learning using a cross-entropy loss function with ground-truth labels; and fine-tuning the updated LLM via reinforcement learning with human feedback (RLHF) using a reward model and a proximal policy optimization (PPO) model to produce an LLM-trained ML model.

In one or more embodiments, pre-training the base LLM may include feeding the library of training prompts and training completions to the base LLM, and adjusting the base LLM's parameters through backpropagation. In one or more embodiments, updating the base LLM via the supervised learning may include measuring a difference between the base LLM's predictions and the ground-truth labels to minimize the cross-entropy loss function, and updating the base LLM's parameters based on the measured difference.

In one or more embodiments, the training of the LLM-trained ML model may further include, prior to performing the fine-tuning via RLHF, applying a low-rank adaptation (LoRA) technique of re-parameterization to the updated LLM using a parameter-efficient fine-tuning (PEFT). In one or more embodiments, applying the LoRA technique for PEFT may include freezing original LLM weights, injecting 2 rank decomposition matrices, and training weights of smaller matrices.

In one or more embodiments, fine-tuning the updated LLM via RLHF may include aligning behaviors of the updated LLM with human preferences via annotation with labels, recognizing preferred model outputs of the updated LLM in a pattern, and automating the fine-tuning of the updated LLM based on the recognized pattern.

In various embodiments, a system for detecting fraud may utilize the AI-based method S200 for monitoring alerts and/or the LLM-trained ML model used in the method S200.

What is claimed is:

1. A method for training a machine learning (ML) model using a large language model (LLM), which method comprises:
receiving tabular data for training the ML model;
generating one or more natural-language strings comprising information from the tabular data;
generating, via a base LLM, one or more prompts and completions based on the one or more generated natural-language strings;
pre-training the base LLM using a plurality of generated prompts and completions;
updating the base LLM via supervised learning using a cross-entropy loss function with ground-truth labels; and
fine-tuning the updated LLM via reinforcement learning with human feedback (RLHF) using a reward model and a proximal policy optimization (PPO) model to produce an LLM-trained ML model.

2. The method of claim 1, wherein pre-training the base LLM comprises:
feeding the plurality of generated prompts and completions to the base LLM, and
adjusting the base LLM's parameters through backpropagation.

3. The method of claim 2, wherein updating the base LLM via the supervised learning comprises:
measuring a difference between the base LLM's predictions and the ground-truth labels to minimize the cross-entropy loss function, and
updating the base LLM's parameters based on the measured difference.

4. The method of claim 1, further comprising:
prior to performing the fine-tuning via RLHF, applying a low-rank adaptation (LoRA) technique of re-parameterization to the updated LLM using a parameter-efficient fine-tuning (PEFT).

5. The method of claim 4, wherein applying the LoRA technique for PEFT comprises:
freezing original LLM weights,
injecting 2 rank decomposition matrices, and
training weights of smaller matrices.

6. The method of claim 1, wherein fine-tuning the updated LLM via RLHF comprises:
aligning behaviors of the updated LLM with human preferences via annotation with labels,
recognizing preferred model outputs of the updated LLM in a pattern, and
automating the fine-tuning of the updated LLM based on the recognized pattern.

7. The method of claim 1, wherein the completions are provided by the base LLM, or another large language model, in response to the one or more prompts, and wherein each completion comprises a query input and a query output.

8. The method of claim 1, further comprising:
benchmarking performance of the fine-tuned LLM to validate completion of training for the LLM-trained ML model.

9. The method of claim 8, wherein the benchmarking comprises:
optimizing true positive rate (sensitivity) values versus false positive rate (specificity) for the LLM-trained ML model, and
producing a chart or a plot displaying the benchmarked performance of the LLM-trained ML model.

10. A system for detecting fraud which utilizes a machine learning model trained using a large language model according to the method of claim 1.

11. An artificial intelligence (AI)-based method for monitoring alerts, the method comprising:
receiving a request for evaluating an alert to predict whether the alert warrants an investigation, wherein the alert is associated with suspicious activities listed in tabular data;
creating a plurality of prompts and completions from the tabular data;
generating, via a large language model (LLM)-trained machine learning (ML) model, a predictive score based on the plurality of prompts and completions, wherein each prompt and its accompanying completion are used as input into the LLM-trained ML model, wherein the predictive score indicates whether any of the suspicious activities warrant an investigation;
comparing the predictive score to a threshold value for classification; and
providing an alert prioritization based on the classification of the predictive score.

12. The AI-based method of claim 11, wherein the LLM-trained ML model is trained using a library of training prompts and training completions, and wherein the training of the LLM-trained ML model comprises:
pre-training a base LLM using the library of training prompts and training completions;
updating the base LLM via supervised learning using a cross-entropy loss function with ground-truth labels; and
fine-tuning the updated LLM via reinforcement learning with human feedback (RLHF) using a reward model and a proximal policy optimization (PPO) model to produce an LLM-trained ML model.

13. The AI-based method of claim 12, wherein pre-training the base LLM comprises:
feeding the library of training prompts and training completions to the base LLM, and
adjusting the base LLM's parameters through backpropagation.

14. The AI-based method of claim 13, wherein updating the base LLM via the supervised learning comprises:
measuring a difference between the base LLM's predictions and the ground-truth labels to minimize the cross-entropy loss function, and
updating the base LLM's parameters based on the measured difference.

15. The AI-based method of claim 11, wherein the training of the LLM-trained ML model further comprises:
prior to performing the fine-tuning via RLHF, applying a low-rank adaptation (LoRA) technique of re-parameterization to the updated LLM using a parameter-efficient fine-tuning (PEFT), wherein applying the LoRA technique for PEFT comprises:
freezing original LLM weights,
injecting 2 rank decomposition matrices, and
training weights of smaller matrices.

16. The AI-based method of claim 11, wherein fine-tuning the updated LLM via RLHF comprises:
aligning behaviors of the updated LLM with human preferences via annotation with labels,
recognizing preferred model outputs of the updated LLM in a pattern, and
automating the fine-tuning of the updated LLM based on the recognized pattern.

17. A system for detecting fraud which utilizes the AI-based method of claim 11.

18. An artificial intelligence (AI)-based fraud detection system for monitoring alerts, comprising:
one or more processors and a non-transitory computer readable medium operably coupled thereto, the non-transitory computer readable medium comprising a plurality of instructions stored in association therewith that are accessible to, and executable by, the one or more processors, to perform alert analysis operations, which comprise:
receiving a request for evaluating an alert to predict whether the alert warrants an investigation, wherein the alert is associated with suspicious activities listed in tabular data;
creating a plurality of prompts and completions from the tabular data;
generating, via a large language model (LLM)-trained machine learning (ML) model, a predictive score based on the plurality of prompts and completions, wherein each prompt and its accompanying completion are used as input into the LLM-trained ML model, wherein the predictive score indicates whether any of the suspicious activities warrant an investigation;
comparing the predictive score to a threshold value for classification; and
providing an alert prioritization based on the classification of the predictive score.

19. The AI-based fraud detection system of claim 18, wherein the LLM-trained ML model is trained using a library of training prompts and training completions, and wherein the training of the LLM-trained ML model comprises:
pre-training a base LLM using the library of training prompts and training completions;
updating the base LLM via supervised learning using a cross-entropy loss function with ground-truth labels; and
fine-tuning the updated LLM via reinforcement learning with human feedback (RLHF) using a reward model and a proximal policy optimization (PPO) model to produce an LLM-trained ML model.

20. The AI-based fraud detection system of claim 19, wherein updating the base LLM via the supervised learning comprises:
measuring a difference between the base LLM's predictions and the ground-truth labels to minimize the cross-entropy loss function, and
updating the base LLM's parameters based on the measured difference.

21. The AI-based fraud detection system of claim 19, wherein the training of the LLM- trained ML model further comprises:
prior to performing the fine-tuning via RLHF, applying a low-rank adaptation (LoRA) technique of re-parameterization to the updated LLM using a parameter-efficient fine-tuning (PEFT), wherein applying the LoRA technique for PEFT comprises:
freezing original LLM weights,
injecting 2 rank decomposition matrices, and
training weights of smaller matrices.
